(19) United States
(12) Patent Application Publication
(10) Pub. No.: US 2013/0045709 A1
(43) Pub. Date: Feb. 21, 2013

(54) Mobile Integrated Billable hour management system and method

(71) Applicant: Alexander Chen, Irvine, CA (US)

(72) Inventor: Alexander Chen, Irvine, CA (US)

(21) Appl. No.: 13/589,970

(22) Filed: Aug. 20, 2012

Related U.S. Application Data
(60) Provisional application No. 61/525,065, filed on Aug. 18, 2011.

(51) Int. Cl. H04W 4/26

(52) U.S. Cl. 455/406

(57) ABSTRACT

A computer-implemented method and system for managing billable hours, the method including the selecting a client from an electronic client directory upon receiving the client's contact for a service; the launching a digital timer for the selected client to record time spent for the requested service; stopping the timer when the service provided for said contact is done; an updating the client's account with the recorded time.

### CROSS-REFERENCE TO RELATED APPLICATION

This application claims the benefit of priority under 35 U.S.C. 119(e) to the filing date of U.S. provisional patent application No. 61/525,065 “Application for Billing for Smart phones” which was filed on Aug. 18, 2011, and which is incorporated herein by reference in its entirety.

### FIELD OF THE INVENTION

The disclosed subject matter relates generally to an integrated billable hour management system and, more particularly, to a system and method for managing billable hours using a mobile computing platform and a mobile device.

### BACKGROUND

Many professionals, such as lawyers and psychotherapists, customarily bill clients by the hour. Before spreadsheet software, professionals recorded their billing hours manually using time ledgers. Since their billable hour management system was tied to physical paper ledgers, they either were tied to their desk at the office or traveled with their ledgers in order to maintain accurate records of their productivity and time. If the books were too cumbersome to carry around or they unexpectedly received a work request away from their office, they had to record. the billable hours temporarily and subsequently transfer the recorded hours to the ledgers when they returned to their office. This method often produced inaccuracies due to situations such as misplaced loose papers or forgotten numbers, Whether the professional would then underestimate or overestimate their time, the estimates would not be a true reflection of their efforts.

Moreover, at month ends, they would spend resources, their own effort or their assistants', to do the necessary accounting so that they could produce bills for clients and get paid. This effort involves at the minimum transferring the recorded hours to the accounting system. Since this is a manual process, errors are expected. Furthermore, at large companies, the effort could take days or weeks to complete.

Recently, with the advent of computer technologies, professionals have employed software to record and track their billable hours electronically. With the advent of hardware technologies, these professionals no longer need to carry paper ledgers with them. However, they still find themselves entering billable hours manually into the repository of the software they use to track billable hours. They still forget the billable hours they thought they had committed in their memories when they unexpectedly received work requests. They continue to estimate the billable hours. When they manage to maintain perfect records, they would still spend considerable resource to transfer the recorded billable hours to the billing software if their record keeping software is not integrated with the billing software.

Using a manual record keeping system, the professionals must constantly remind themselves to record billable hours, and thus get distracted from the productive work they are doing. This annoying interruption on their chain of thoughts makes the work less pleasant and less productive. A June 2009 survey of lawyers by Chrometa.com, a time keeping software company, found that, of the lawyers that responded, all agreed that tracking time is the worst part of their jobs. Clearly current solutions have not fully ameliorated the unpleasant aspect of tracking billable hours. It is conceivable that, if one does not find the task pleasant, he will either choose not to do it, resulting in loss of revenue, or he will find his work more unpleasant and stressful, resulting in a less productive work environment.

### OBJECT OF THE INVENTION

It is an object of the invention to provide an integrated billable hour management system.

It is also an object of the invention to eliminate the annoying effect of the wasteful manual effort of tracking billable hours and producing monthly bills.

It is also an object of the invention to allow professionals to track their billable hours effortlessly and save their valuable time to work on billable services.

It is also an object of the invention to integrate billable hour record keeping with an electronic billing system.

It is also an object of the invention to create the first integrated billable hour management system.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with one embodiment, a method for managing billable hours comprises: selecting a client from an electronic client directory upon receiving the client's contact for a service; launching a digital timer for the selected client to record time spent for the requested service; stopping the timer when the service provided for said contact is done; and updating the client's account with the recorded time.

In accordance with one or more embodiments, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

In one aspect of the invention, a computer-implemented method for managing billable hours is disclosed, the method comprising: providing a network; providing a host computer system wherein the host computer is connected to the network wherein the host computer provides a central billing system; providing a mobile smartphone device wherein the mobile smartphone device is connected to the central billing system via the network; the mobile smartphone device comprising a billing application wherein the billing application is comprised of an electronic client directory and a digital timer; the billing application automatically launches the electronic client directory when the mobile smartphone device receives a client's request; selecting a client from the electronic client directory; launching the digital timer to record time spent for the client request; stopping the digital timer when the client request is completed the billing application recoding data from the digital timer; and updating the central billing system with the data.

In one embodiment, the electronic directory may be an electronic phone directory, an electronic address book, or any data structure for keeping client information. In one embodiment the client's request is a phone call. In one embodiment the client's request is an email. In one embodiment the billing application recognizes the client's request and automatically select the client from the electronic directory. In one embodiment the client is assigned a unique identifier within the electronic directory for easy identification. In one embodiment the client is grouped within a priority list of frequent requester within the electronic directory. In one embodiment the billing application automatically launches the digital timer to record time spent for the client request. In one embodiment the billing application automatically stops the digital timer when the client request is completed.

In another aspect of the invention, a computer-implemented system for managing billable hours is disclosed , the system comprising a network; a host computer system wherein the host computer is connected to the network wherein the host computer provides a central billing system; a mobile smartphone device wherein the mobile smartphone device is connected to the central billing system via the network; the mobile smartphone device comprising a billing application wherein the billing application is comprised of an electronic client directory and a digital timer; the billing application automatically launches the electronic client directory when the mobile smartphone device receives a client's request, wherein a client is selected from the electronic client directory; wherein the digital timer is launched to record time spent for the client request; wherein the digital timer is stopped when the client request is completed; wherein the billing application recoding data from the digital timer; and update the central billing system with the data.

In one embodiment the electronic directory may be an electronic phone directory, an electronic address book, or any data structure for keeping client information. In one embodiment the client's request is a phone call. In one embodiment the client's request is an email. In one embodiment the billing application recognizes the client's request and automatically select the client from the electronic directory. In one embodiment the client is assigned a unique identifier within the electronic directory for easy identification. In one embodiment the client is grouped within a priority list of frequent requester within the electronic directory. In one embodiment the billing application automatically launches the digital timer to record time spent for the client request. In one embodiment the billing application automatically stops the digital timer when the client request is completed.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates exemplary scenarios of requests for billable services, and a professional's possible digital tools to track billable time. (add a laptop, computer, etc.), in accordance with one or more embodiments.

FIG. 2 illustrates an exemplary client directory wherein clients' information and Ids are maintained, in accordance with one embodiment.

FIG. 3 illustrates an exemplary context menu wherein a time tracking function is provided, in accordance with one embodiment.

FIG. 4 illustrates an exemplary status bar of a mobile device wherein a running digital timer is displayed and showing a recorded time, in accordance with one embodiment.

FIG. 5 illustrates and exemplary time tracking menu wherein the time tracking process could be stopped and saved, paused, continued after a pause, or cancelled and exited, in accordance with one embodiment.

FIG. 6A, 6B and 6C are exemplary flow diagrams of a method of tracking and managing billable hour, in accordance with one embodiment.

FIGS. 7A and 7B are block diagrams of hardware and software environments in which the disclosed systems and methods may operate, in accordance with one or more embodiments.

FIGS. 8 depicts an exemplary network environment that supports a virtual infrastructure, in accordance with one or more embodiments.

Features, elements, and aspects that are referenced by the same numerals in different figures represent the same, equivalent, or similar features, elements, or aspects, in accordance with one or more embodiments.

### DETAILED DESCRIPTION OF EXAMPLE EMBODIMENTS

In the following, specific details are set forth to provide a thorough description of various embodiments. Certain embodiments may be implemented without these specific details or with some variations in detail. In some embodiments, certain features are described in less detail so as not to obscure other aspects. The level of detail associated with each of the elements or features should not be construed to qualify the novelty or importance of one feature over the others.

Furthermore, the detailed features disclosed below are examples and should not be construed as the extent of the claimed subject matter. Those particular details are provided for a better understanding of the underlying features and elements.

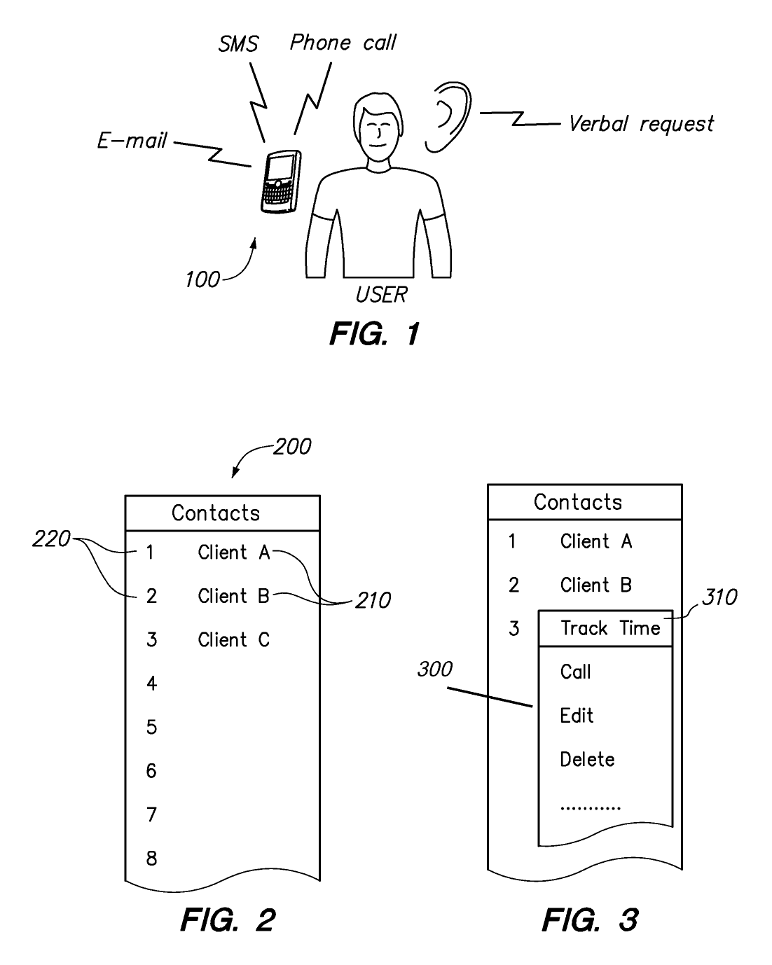

Referring to FIG. 1, in one or more embodiments, a client may contact a professional through different communication channels, such as email, text messaging, telephone call or in-person verbal request for a billable service. The professional may use various computing devices, such as a mobile smartphone, a mobile tablet, a mobile computing machine or a local computing machine, to track billable time using the method disclosed therein.

Referring to FIG. 2, in one embodiment, upon receiving a service request, a professional may quickly access an electronic client directory 200, like the one depicted in the diagram. In one embodiment, upon receiving a call or an email on the mobile smart phone from the client, the mobile smart phone automatically launches a smartphone billing application wherein this application is comprised of the electronic client directory 200. In one embodiment, client names 210 may be displayed in alphabetical order and be pointers to the clients' full data records. Although not shown in FIG. 2, in another embodiment, both clients' names and their file numbers or their initials and file numbers may be displayed and be pointers. In addition, each client may be assigned a unique identifier (“ID”) 220. In one embodiment, this unique Id 220 may be unique throughout the billing and accounting system that is driven by and supporting the disclosed time tracking component. In another embodiment, this unique Id 220 may have no significant function other than being the next incremental number on the list. It is appreciated that an implementation of the current disclosed method may choose a client identification scheme in between the globally unique Ids and no unique Ids.

In one embodiment, Id 220 may also be used to identify preferred clients. The preferred clients may be the first ten on the list and are selected to the list according to some criteria set by the professional. Although not shown in FIG. 2, each client on the preferred list may also be assigned a numeric shortcut key, which the professional may quickly select using the mobile device's or computing machine's keypad.

In one embodiment, the electronic client directory 220 may have expansive data structure, wherein besides the traditional data such as name, address and telephone number, said data structure can accommodate other data such as client unique identifier, case identifier, billing account identifier, billing rate, etc. In another embodiment, instead of being stored locally, the electronic directory may be stored remotely on a virtualized data storage environment accessible via a secured network. When a request for the directory is sent over the secured network, the directory may be sent to the local storage via the same network or another secured network due to external requirements.

Although not shown in FIG. 2, in one embodiment, instead of a list format, the client directory may be virtually presented with adjacent small rectangle tiles in a grid-like pattern. The professional selects the client by selecting the client's tile. In another embodiment, the professional may speak to the computing device via a connected or built-in microphone to select the client. A person skilled in the art would anticipate that other forms of communication may be employed for the professional to issue the selection and other subsequent commands to the device. In yet another embodiment, the client directory 200 provides for a function to add new client information. In yet another embodiment, the client directory 200 provides for a function to deactivate the billing application since the call is not related to a client matter. In one embodiment, after the electronic directory 220 is launched, the user manually selects the client ID. In yet another embodiment, the client directory 200 recognizes the client request as to which client this is initiated from and automatically selects the client ID. In yet another embodiment, the client directory 220 suggests a number of client ID based on its recognition of client contacts.

Referring to FIG. 3, in one implementation, a context menu 300 may be provided to launch a digital timer for the requested service. In another embodiment, the mobile phone application is comprised of this context menu 300. In one embodiment, this module is launched automatically once the professional selects the client ID. In another embodiment, the professional may press and hold on the client name on the client list to invoke the context menu 300, and select Track Time option 310 to start recording billable time. In yet another implementation, the professional may speak to the computing device to issue same commands.

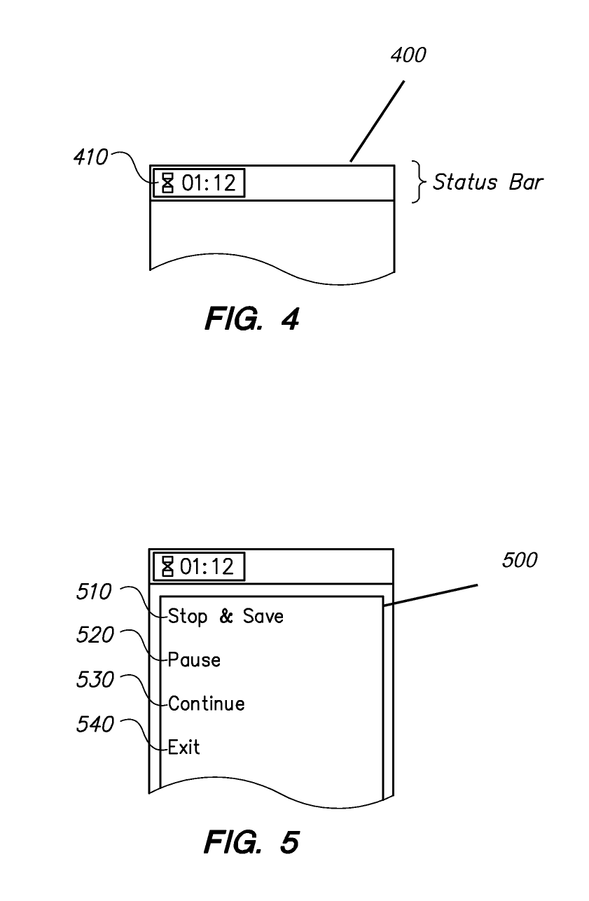

Referring to FIG. 4, in one embodiment, said digital timer module may run in the background and present itself on the mobile computing device's application status bar 400 with a small box 410 containing an hour glass animation and a digital timer, which shows the total elapsed time. The display may be configurable to display additional useful or interesting information. A person skilled in the art, in another embodiment, may decide to display the elapsed time in other manners so as to meet aesthetical or practical requirements.

Referring to FIG. 5, in one embodiment, the professional may interact with the timer using a provided context menu 500. The professional would cause the computing device to select the hour glass icon on the status bar to invoke the context menu 500. The context menu 500 may have options to stop & save 510, to pause 520, to continue 530 and to cancel & exit 40. The professional may choose Stop & Save option 510 when he or she finishes the requested service and wants to record the recorded billable time. In another embodiment, once the professional hangs up the phone with the client, the billing application automatically prompts the context menu 500 to request the professional to give instruction to either stop & save the time recorded 510, to pause the time recording 520, to continue time recording 530 or the exit. For example, while working on the requested service, if there is a more urgent matter requiring his or her immediate attention, the professional may pause the timer by selecting Pause option 520 on the context menu. When he or she returns to work on the requested service, the professional may continue recording time by selecting Continue option 530 on the context menu. At any time after the timer is started, if the professional decides to not record billable time any more for some reason, he or she may select Cancel & Exit option 540 on the context menu. In another embodiment, the professional may speak to the computing device to issue same commands.

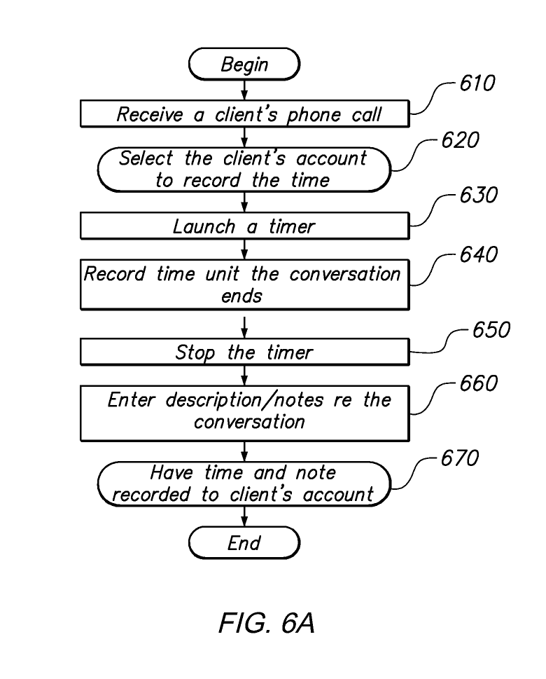

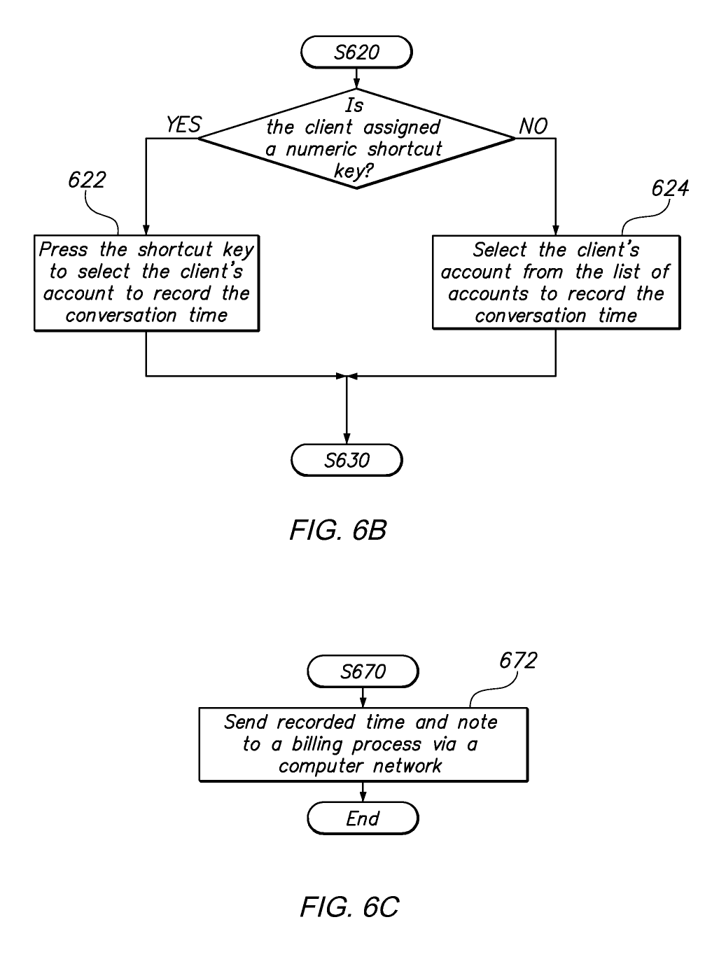

Referring to FIG. 6A, in one implementation, upon receiving a request from a client for a billable service (S610), such as a phone call, the professional may access a client directory, or the client directory is automatically launched, like the one depicted in FIG. 2, select the client (S620) and cause the computing device to launch a digital timer for the client's requested service (S630). The digital timer may run in the background and record the billable time until the billable work is done (S640). At this time, the professional may cause the computing device to invoke a context menu like the one in FIG. 5 and select an option to stop the timer and save the recorded billable time (S640). In one embodiment, an option to enter a text relating to the request, billable work or time may be provided (S660). After this step, the billable time and the optional text are saved to the client's account (S670).

Referring to FIG. 6B, in one implementation, step S620 may simply consist of pressing a key on the computing device's keypad if the client is preferred and assigned a numeric shortcut key. The professional may press the appropriate key on the computing device's keypad to launch a digital timer and start recording billable time for the requested service.

Referring to FIG. 6C, in one implementation, step S670 may be more elaborately implemented such that the recorded billable time and optional text, instead of being saved locally on the computing device, may be sent and saved remotely in a virtualized data storage of a central billing system on a secured computer network (S672). In this implementation, a globally unique ID may be needed to distinguish different clients who transact with different professionals of same or different offices in different regions of different countries.

References in this specification to “implementation” or “embodiment” phrase mean that the described element, feature, structure or characteristic is included in at least one embodiment of the disclosed subject matter. Those references should not be construed as referring to the same embodiment, nor should such phrases be interpreted as referring to embodiments that are mutually exclusive with respect to the described element, feature, structure or characteristic.

In different embodiments, the claimed subject matter may be implemented as a hardware only, software only or a combination thereof solution. Further, computing systems and software disclosed herein may comprise a controlled computing environment that may contain hardware components and logic code executed to perform methods or processes that achieve the results contemplated herein. Said methods and processes, when performed by a general purpose computing system or machine, convert the general purpose machine to a specific purpose machine.

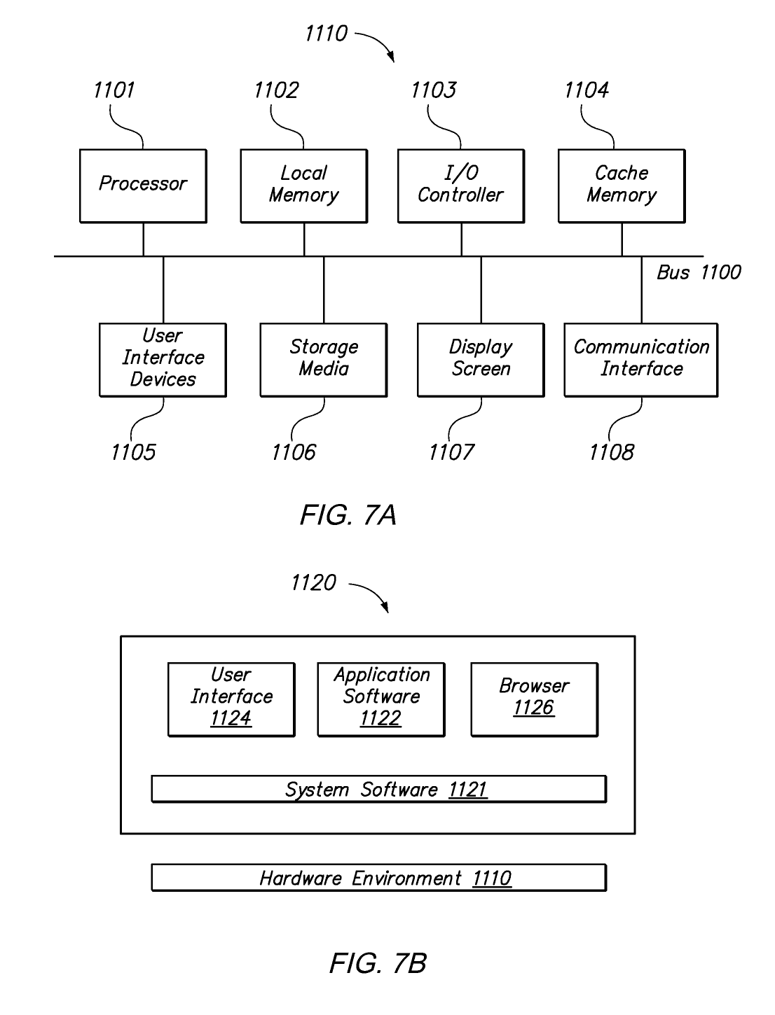

In FIGS. 7A and 7B, in one embodiment, a computing environment may comprise a hardware environment 1110 and a software environment 1120. The hardware environment 1110 may comprise logic circuits, CPUs, memory units, storage units or other machinery and equipments that provide an execution environment for the software in software environment 1120. In turn, the software environment 1120 may provide the execution or system configuration instructions for the various elements of hardware environment 1110.

In FIG. 7A, the disclosed method and logic may be implemented in the form of machine readable code executed over one or more computing systems in the exemplary hardware environment 1110. As illustrated, hardware environment 1110 may comprise a processor 1101, which cooperates with storage elements by way of a system bus 1100. The storage elements, for example, may comprise local memory 1102, storage media 1106, cache memory 1104 or other machine-usable or computer readable media, which may include any recordable article that can contain, store, communicate, propagate or transport program code. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave.

In one embodiment, processor 1101 loads executable code from storage media 1106 to local memory 1102. Frequently executed code is cached in cache memory 1104 to reduce executable code loading and optimize processing time. One or more user interface devices 1105 (e.g., keyboard, pointing device, etc.) and a display screen 1107 may be connected to the other elements in the hardware environment 1110 either directly or through an I/O controller 1103. A communication unit 1108, such as a network adapter, may be provided to enable the hardware environment 1110 to communicate with local or remote computing systems, printers and storage devices via a private or public networks (e.g., the Internet).

Although all elements are shown, hardware environment 1110, in certain implementations, may not include some or all the above elements, or may comprise additional elements to provide supplemental functionality or utility. Depending on the contemplated use and configuration, hardware environment 1110 may be as large as a server rack with multiple CPUs and memory units, a separate SAN storage and additional solid-state disks, as small as a smartphone, or other similar hardware platforms that have information processing or data storage capabilities.

In some embodiments, communication element 1108 acts as a data communication port to provide means of communication with one or more computing systems by sending and receiving digital, electrical, electromagnetic or optical signals that carry analog or digital data streams representing various types of information, including program code. The communication may be established by way of a wired or wireless computer network, including without limitation propagation over a carrier wave.

It is noteworthy that, in one embodiment, the disclosed methods and software elements may also be implemented as embedded code in said hardware elements by way of configured and programmed processors, application specific integrated circuits (ASICs), field programmable gate arrays (FPGAs) and digital signal processors (DSPs), for example.

In FIG. 7B, software environment 1120 may be generally divided into two classes: system software 1121 and application software 1122, which are executed on one or more hardware environments 1110. In one embodiment, the disclosed methods and processes may be implemented as system software 1121, application software 1122, or a combination thereof. System software 1121 may comprise one or more programs, such as an operating system (OS) or an information management system, that operates hardware elements by way of issuing computer machine code. Application software 1122 may comprise program code, data structures, firmware, resident software, microcode or any other form of information or routine that may be read, analyzed or executed by a processor 1101.

Moreover, application software 1122 may comprise one or more computer programs that, when executed, cause the system software 1121 to operate hardware elements by way of pseudo code, after being loaded from storage media 1106 into local memory 1102. In certain implementation, application software 1122 may comprise client software and server software; that is, client software may be executed on a client computing system that is distinct and separable from a server computing system on which server software is executed. Software environment 1120 may also comprise browser software 1126 for accessing data available over computing networks and a user interface 1124 (e.g., a graphical user interface (GUI)) for receiving users' commands and data.

It is appreciated that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

It is also appreciated that a software embodiment may include firmware, resident software, micro-code, etc. Certain software or hardware components may generally be referred to herein as a “circuit,” “unit”, “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium.

In the context of this document, a computer readable storage medium may be any tangible medium that can contain, or store a program for use by or in connection with an instruction execution system, apparatus, or device. A computer readable signal medium may include a propagated data signal, such as electro-magnetic, optical, or any combination thereof signal, with computer readable program code embodied therein, for example, in baseband or as part of a carrier wave. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination thereof. Computer program code for carrying out the disclosed operations may be written in any combination of one or more programming languages, such as C, C++, Smalltalk, Java or the like.

The program code may execute entirely or partly on the user's computing device or partly or entirely on a remote computer server. In the latter scenario, the remote computer server may be connected to the user's computing device through any type of network, including a local area network (LAN), a wide area network (WAN), or a wireless broadband network.

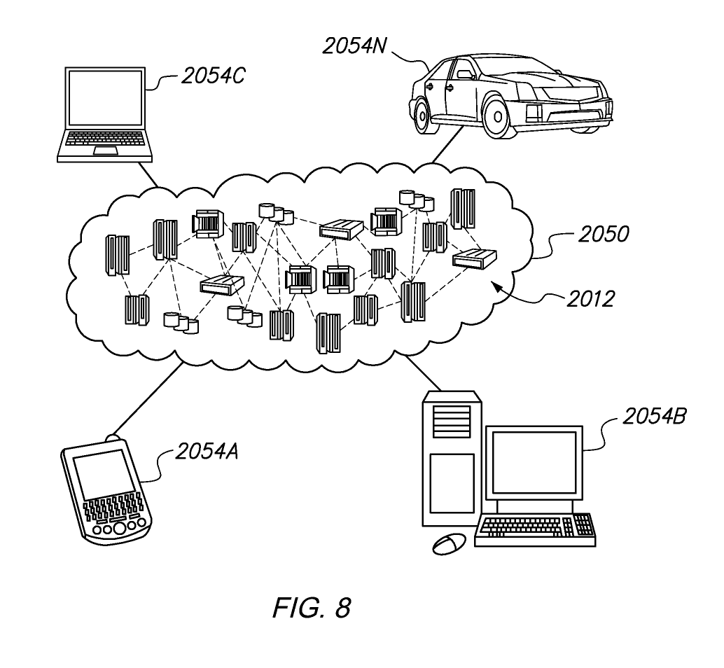

Referring now to FIG. 8, a cloud computing environment 2050 comprises one or more cloud computing nodes 2012 with which local computing devices used by cloud consumers, such as, smartphones or personal digital assistant (PDA) 2054A, desktop computer 2054B, laptop computer 2054C, and/or automobile computer system 2054N may communicate.

Nodes 2012 may communicate with one another. They may be grouped (not shown) physically or virtually, in one or more networks, such as Private, Community, Public, or Hybrid clouds, or a combination thereof. This allows cloud computing environment 2050 to offer infrastructure, platforms and/or software as virtual services for which a cloud consumer does not need to know their structure details nor to maintain resources on a local computing device.

It is understood that the types of computing devices 54A-N shown in FIG. 8 are intended to be illustrative only and that computing nodes 2012 and cloud computing environment 2050 may communicate with any type of computing device over any type of network and/or network addressable connection (e.g., using a web browser).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general or special purpose computing machine or other programmable data processing apparatus for execution as a means for implementing the functions or acts specified in the flowchart or block diagram block or blocks. These computer program instructions may be stored in a computer readable storage medium that, upon receiving instructions from the processor, can produce an article of manufacture including instructions for the processor to implement the function or act specified in the flowchart or block diagram block or blocks.

The computer program instructions may also be loaded onto a computer, other programmable data processing apparatus, or other computing devices and cause them to perform a series of operations as means of implementing the functions or acts specified in the flowchart or block diagram block or blocks.

The flowchart and block diagrams in the figures illustrate the architecture, functionality, and operation of possible implementations of systems, methods and computer program products according to the disclosed method and system. In this regard, each block in the flowchart or block diagrams may represent a module, segment, or portion of code, which comprises one or more executable instructions for implementing the specified logical functions. It is understood that the order of the logical functions depicted in the diagrams is one example; thus, in some alternative implementations, the logical functions may occur in any order or out of the order noted in the figures. For example, two blocks shown in succession may, in fact, be executed substantially concurrently or in the reverse order, or collapsed into one instruction by a special purpose system.

The claimed subject matter has been provided here in specific details with reference to one or more features or embodiments. It is appreciated that changes and modifications may be applied to said embodiments without limiting or departing from the generally intended scope. These and various other adaptations and combinations of said embodiments are within the scope of the disclosed subject matter as defined by the claims and their full set of equivalents.

What is claimed is:

1. A computer-implemented method for managing billable hours, the method comprising:
a. providing a network;
b. providing a host computer system wherein said host computer is connected to said network wherein said host computer provides a central billing system;
c. providing a mobile smartphone device wherein said mobile smartphone device is connected to said central billing system via said network;
d. said mobile smartphone device comprising a billing application wherein said billing application is comprised of an electronic client directory and a digital timer;
e. said billing application automatically launches said electronic client directory when said mobile smartphone device receives a client's request;
f. selecting a client from said electronic client directory;
g. launching said digital timer to record time spent for said client request;
h. stopping said digital timer when said client request is completed
i. said billing application recoding data from said digital timer; and
j. updating said central billing system with said data.

2. The method of claim 1, wherein said electronic directory may be an electronic phone directory, an electronic address book, or any data structure for keeping client information.

3. The method of claim 1, wherein said client's request is a phone call.

4. The method of claim 1, wherein the client's request is an email.

5. The method of claim 1, wherein said billing application recognizes said client's request and automatically select said client from said electronic directory.

6. The method of claim 1, wherein said client is assigned a unique identifier within said electronic directory for easy identification.

7. The method of claim 1, wherein said client is grouped within a priority list of frequent requester within said electronic directory.

8. The method of claim 1 wherein said billing application automatically launches said digital timer to record time spent for said client request.

9. The method of claim 1 wherein said billing application automatically stops said digital timer when said client request is completed.

10. A computer-implemented system for managing billable hours, the system comprising:
a. a network;
b. a host computer system wherein said host computer is connected to said network wherein said host computer provides a central billing system;
c. a mobile smartphone device wherein said mobile smartphone device is connected to said central billing system via said network;
d. said mobile smartphone device comprising a billing application wherein said billing application is comprised of an electronic client directory and a digital timer;
e. said billing application automatically launches said electronic client directory when said mobile smartphone device receives a client's request, wherein a client is selected from said electronic client directory; wherein said digital timer is launched to record time spent for said client request; wherein said digital timer is stopped when said client request is completed; wherein said billing application recoding data from said digital timer; and update said central billing system with said data.

11. The system of claim 10, wherein said electronic directory may be an electronic phone directory, an electronic address book, or any data structure for keeping client information.

12. The system of claim 10, wherein said client's request is a phone call.

13. The system of claim 10, wherein the client's request is an email.

14. The system of claim 10, wherein said billing application recognizes said client's request and automatically select said client from said electronic directory.

15. The system of claim 10, wherein said client is assigned a unique identifier within said electronic directory for easy identification.

16. The system of claim 10, wherein said client is grouped within a priority list of frequent requester within said electronic directory.

17. The system of claim 10 wherein said billing application automatically launches said digital timer to record time spent for said client request.

18. The system of claim 10 wherein said billing application automatically stops said digital timer when said client request is completed.
